(19) United States
(12) Patent Application Publication
(10) Pub. No.: US 2018/0194227 A1
(43) Pub. Date: Jul. 12, 2018

(54) VEHICLE WITH MULTIPLE VEHICLE DRIVER POSITION

(71) Applicant: FORD GLOBAL TECHNOLOGIES, LLC, Dearborn, MI (US)

(72) Inventors: Uwe Gussen, Huertgenwald (DE); Christoph Arndt, Moerlen (DE); Frederic Stefan, Aachen (DE); Frank Petri, Erftstadt (DE)

(73) Assignee: FORD GLOBAL TECHNOLOGIES, LLC, Dearborn, MI (US)

(21) Appl. No.: 15/842,092

(22) Filed: Dec. 14, 2017

(30) Foreign Application Priority Data
Jan. 9, 2017 (DE) 10 2017 200 194.1

(51) Int. Cl. B60K 35/00; B60N 2/00; H04N 21/41; H04N 21/422; H04N 21/414; H04N 21/4415

(52) U.S. Cl. CPC B60K 35/00; B60N 2/002; H04N 21/4122; H04N 21/42222; H04N 21/41422; B60N 2/0292; H04N 21/4415; B60K 2350/352; B60K 2350/901; B60K 2350/921; B60K 2350/962; H04N 21/42224

(57) ABSTRACT

A vehicle has multiple alternative driving positions, with one or more visual displays assigned to each driving position for depicting content required to drive the vehicle. A selection device identifies a vehicle occupant as a driver, determines a location of the driver within the vehicle, and designates as the active driving position whichever of the alternative driving positions the driver occupies. A processing unit transfers video relevant to vehicle operation to one or more of the displays visible from the active driving position and enables control of the vehicle from the active driving position. The selection device may also check whether the vehicle occupant meets one or more conditions required to be designated as the vehicle driver, and may determine an identity associated with the driver so that the displayed video is customized or personalized in accordance with that identity.

### CROSS-REFERENCE TO RELATED APPLICATIONS

This application claims foreign priority benefits under 35 U.S.C. § 119(a)-(d) to DE Application 10 2017 200 194.1 filed Jan. 9, 2017, which is hereby incorporated by reference in its entirety.

### TECHNICAL FIELD

The invention relates to a vehicle having multiple possible vehicle driver positions, and to such a vehicle having visual display screens that allow control from any of the possible driver positions.

### BACKGROUND

In future, vehicles will be increasingly developed that assist and automate the actual driving process as far as autonomous, i.e. independent, driving. This may lead, inter alia, to today's established splitting of a vehicle interior with front seats, rear seats, driver's position front left (driving on the right) or right (driving on the left) etc. no longer needing to be regarded as prescribed.

However, it may remain necessary to allow the driver to take action in the driving procedure at least in particular driving situations and to subject the vehicle to the control of the driver. Furthermore, non-autonomous driving of the vehicle may also be desired for other reasons, e.g. as a leisure occupation.

Furthermore, some user interfaces (Human-Machine-Interface, HMI) between vehicle driver and vehicle are problematic, since, by way of example, the accessibility of displays, switches, levers, pushbuttons etc. is not always sufficiently ensured, this aspect being important particularly for older motor vehicle drivers. Specifically, this may be the case when using different or rarely used vehicles, for example a rental car, leased vehicle, or a third car.

Moreover, problems may arise from the poor accessibility of onboard instruments, such as the heating and ventilation control, a navigation system or an entertainment system, for example. There is admittedly the option of controlling such instruments by means of mobile terminals, for example a smartphone. However, this requires an additional infrastructure, such as access points for the internet and appropriate applications (apps), for example.

### SUMMARY

It is therefore an object of the present invention to specify an option that allows the interior of a vehicle to be used flexibly. In particular, the aim is for it to be possible for an approved and/or designated individual to control the vehicle from any position within the vehicle. In addition, it would be desirable for the vehicle driver to be able to individually customize all necessary onboard instruments to suit his needs, so that traffic safety can be increased.

One aspect of various embodiments is based on the insight that a vehicle can be equipped with displays, for example multi-function displays, that are arranged and embodied such that it is possible for the vehicle to be driven from any position or location within the vehicle. In other words, a vehicle having a “virtual driver's seat” can be provided by virtue of the information necessary for driving the vehicle being provided on multiple displays located so as to be visible from various positions/locations. This provides the option for any vehicle occupant, if need be with the proviso of a valid driver's license, to be designated as the driver and so to be able to drive the vehicle, since it is possible to take control of the vehicle and to depict all the relevant information on appropriate displays from any vehicle interior position.

In this case, the term “virtual” denotes the property of an item not to exist in the form in which it appears to exist, but to resemble, in its essence or its effect, an item existing in this form.

To this end, a vehicle disclosed herein with a flexible, i.e. locally alterable, vehicle driver position has multiple, alternative driving positions for a vehicle driver and displays assigned to each driving position for depicting display content, the displays being arranged such that depicted display content is perceptible from the assigned driving position.

In this case, a vehicle is intended to be understood to mean any mobile means of transport, i.e. a land vehicle, a watercraft, or an aircraft, for example an automobile. The vehicle according to the invention may also be a minibus or a commercial vehicle.

An alternative driving position is intended to be understood to mean a possible position that the vehicle driver can adopt in or on the vehicle. It may be a sitting, lying or standing position, for example. For example, the vehicle seats may be driving positions.

Each alternative position has one or more assigned displays that can depict display content, for example in the form of photographs, graphics, virtual operator control elements, and/or videos of the vehicle environment.

A display is intended to be understood to mean a device for visually communicating and depicting variable information. Such information may, for example, be vehicle-relevant and/or driving-relevant information that the vehicle driver needs.

As such, a display can depict e.g. the speed, the distance traveled, the fuel reserve, or the status (on or off) of turn signals, high beam etc., a planned route (navigation display), or the image from a camera directed at the route, e.g. the camera of a parking assistance system.

A display can alternatively signal and depict further information, e.g. entertainment programs, such as e.g. films, games, etc.

The display may be configured as a thin film transistor touchscreen, a liquid crystal display, or a projection display (head-up display), for example.

The display or displays may also be configured flexibly, i.e. pliably, rigidly, as a touchscreen or as a holographic display. The display or displays may be or can be arranged in the vehicle roof lining, i.e. on the inside of the vehicle roof, on the inside of the doors or windows and/or on the back of the vehicle seats, for example, or can form the listed vehicle parts. By way of example, all the surfaces on hand in the vehicle interior may be configured as a display.

The same display may also be assigned to multiple driving positions. Assignment is effected such that the depicted display content is perceptible, i.e. clearly visible and identifiable, from the assigned driving position(s) to which a display is assigned.

By way of example, the vehicle roof lining may be formed by a display or the vehicle roof lining may have a display arranged in it that is visible from multiple—or even all possible—driving positions. Accordingly, this display is assigned to multiple (or all) alternative driving positions.

Moreover, the disclosed vehicle may have a selection device for selecting the driving position of the vehicle driver. The selection device is used to stipulate the driving position that the vehicle driver is in, i.e. the active driving position is stipulated.

In a simple refinement, it may be a selector switch, e.g. in the form of a manually operated switch (a pushbutton, for example), operable to select the active or actual driving position, i.e. which of the alternative position is to be occupied by the vehicle driver. By way of example, each vehicle seat may have a selector switch arranged at it that, when operated, defines this vehicle seat as the active driving position (that from which the vehicle is currently able to be controlled/driven).

According to different possible embodiments, the selection device can select the driving position by means of voice control or the selection device may be configured for selection by means of voice control, the selection being made on the basis of commands given verbally.

According to further embodiments, the selection of the active driving position can be made automatically or the selection device may be configured for automatic selection. The automatic selection can be made e.g. by means of face recognition, camera monitoring or weight sensor.

Together with the driving position, the assigned displays are selected at the same time.

The disclosed vehicle may additionally have sensors for ascertaining vehicle-relevant and/or route-relevant data, e.g. temperature sensors, speed sensors, image sensors.

Vehicle-relevant data are understood to mean data relating to the vehicle itself such as e.g. speed, temperature, engine speed, fill level of the tank etc., from which it is in turn possible for information about the vehicle, such as e.g. range, gear recommendation etc., to be derived.

Route-relevant data are, by contrast, data that are associated with the route, i.e. e.g. the road profile, the surrounding traffic etc. By way of example, there may be data from an exterior camera from which an image of the route can be generated.

In addition, the vehicle may have a processing unit that is designed to generate display content by means of the ascertained vehicle-relevant and/or route-relevant data and to transfer the generated display content to the displays assigned to the selected driving position.

In other words, the processing unit is firstly operative to generate content that will communicate visually the information contained in the data gathered by the sensors, and any information derived from the data. Secondly, the processing unit is operative to transfer that visual display content on those displays that are visible to the vehicle driver.

The vehicle according to the invention may be driven from any position in and on the vehicle. The driver's seat is therefore no longer tied to a prescribed position, but rather is virtual instead and, on the one hand, can follow the person who is the vehicle driver inside the vehicle, for example. On the other hand, there is the option of any person in or on the vehicle being able to become the vehicle driver without needing to change seats. By way of example, in the event of acute illness, in the event of malaise or the onset of fatigue, it is possible for a person other than the current vehicle driver to quickly take over driving of the vehicle, since a change of position is not required, which means that traffic safety may be improved.

The vehicle according to the disclosed embodiment additionally allows a new layout or design for the vehicle interior and improved spaciousness to be realized, since the arrangement of conventional, physical operator control elements (such as steering wheel, turn signal lever, light switch etc.) can be dispensed with, since these can be generated virtually by means of multi-function displays. In this respect, the vehicle according to the invention is a bridging technology for future totally autonomous driving. If the displays are not used for driving the vehicle, it is possible for any other display content, e.g. entertainment programs or alternatively design elements, such as e.g. wooden paneling or textile structures, to be depicted.

According to different variant embodiments, the vehicle can additionally have a memory unit for storing data. In this case, the processing unit is additionally operative to select and retrieve the stored data and to generate display content as determined, at least in part, by the retrieved data, which display content is then transferred to the displays assigned to the selected driving position and depicted on said displays.

The stored data may be, by way of example, individual settings of a vehicle driver, such as e.g. a preferred arrangement of different display content on the display or displays, a preferred color scheme, preferred size settings etc. This allows for a vehicle driver to be provided with particular display content at the same or at least a similar position, even if he drives a different or rarely used vehicle, by means of stored individual settings.

In addition, backgrounds or virtual operator control elements to be displayed can also be stored, for example in order to cause a recognition effect for the vehicle driver and to improve his wellbeing. If particular displays or display areas are not needed for the depiction of display contents, it is also possible for data of individual designs, e.g. photographs, textile structures, wooden paneling etc., to be selected, retrieved and depicted from the memory unit.

According to different variant embodiments, the vehicle can additionally have a device for checking a vehicle driving authorization of the vehicle driver and/or an identification device for identifying the vehicle driver.

A device for checking a vehicle driving authorization can ascertain the (approximate) age and/or the state of health of the vehicle driver, for example, and, if need be by comparison against a database, grant or deny the authorization to drive the vehicle. On the basis of the ascertained vehicle driving authorization, it is possible for the supervisory and control functions of the vehicle to be restricted, so that e.g. children can control only passive functions, such as e.g. the ventilation control, and an entertainment program. In addition, it is possible for an order to be output in which the driving of the vehicle should preferably be undertaken, e.g. according to the state of health, fatigue, driver experience etc.

Alternatively or additionally, an identification device may be provided that is used to identify the vehicle driver, so that the display content of the displays can be individually set or customized for the identified vehicle driver, for example. The identification device provided may be a fingerprint scanner, a face or voice recognition device, for example.

The device for checking a vehicle driving authorization and the identification device may be configured physically inside a single device or module. This allows, for example, in a first step, identification of the vehicle driver and, in a second step, the check on the vehicle driving authorization, e.g. by querying a driver's license database.

In addition, there is also the option of linking the identification and authorization devices/modules to the selection device. By way of example, it is then possible for some or all vehicle occupants to be identified and/or the vehicle driving authorization thereof to be checked. Depending on the result of this identification and/or check, e.g. on the basis of the state of health, the selection device can then select the driving position of the vehicle driver automatically or can have its selection options limited as appropriate.

By means of identification of the vehicle driver, it is possible to establish if the vehicle driver changes his position in relation to the vehicle. It is then possible for the displays assigned to the new driving position of the vehicle driver to be individually customized to suit the needs of the vehicle driver. In other words, the vehicle driver can be recognized and, as soon as he changes his position, e.g. his seat, the display content follows him and is displayed on the displays surrounding the vehicle driver in his new position.

According to different variant embodiments, the device for checking the vehicle driving authorization and/or the identification device can have one or more biometric sensors. The biometric sensors used in this regard can be fingerprint scanners, scanners for the hand vein structure or for the ocular fundus, for example.

According to different variant embodiments, one or more displays are configured as flexible, i.e. pliable (able to bend as necessary to conform to and overlay a non-planar surface), displays. This allows simpler customization of the displays to suit the curved and/or irregular contours of the surfaces to be equipped with a display, e.g. in the interior of the vehicle. By way of example, there is the option of equipping all (visible) surfaces in the interior of a vehicle with flexible displays or of constructing them from flexible displays, e.g. by virtue of the inner lining being formed from or comprising flexible displays. By way of example, surfaces such as the dashboard, side panels, rear seat or door linings, vehicle roof linings may be configured as flexible displays.

In combination with further variant embodiments, in which one or more displays are configured as a touchscreen, there is therefore the option of dispensing with some or all of the conventional switches or display apparatuses in the vehicle, so that extensive design flexibility of the vehicle interior is achieved, and also improved spaciousness in the vehicle interior. By way of example, all or any visible surfaces in the vehicle interior may be configured as multi-function touchscreens, so that input of commands is also possible besides the display of virtual measuring instruments.

According to different variant embodiments, operator control elements of the vehicle, such as e.g. steering wheel, gas pedal, brake pedal, gear selector, handbrake, turn signal etc., may be configured virtually on a touchscreen. By way of example, a virtual steering wheel, gas pedal, brake pedal etc. can be displayed on a (multi-function) display.

According to further variant embodiments, the vehicle can additionally have a device for outputting haptic feedback. Such feedback can be output e.g. by means of vibration. By way of example, there is the option of configuring a touchscreen such that it vibrates when touched, e.g. to input a command, and hence signals e.g. the successful input of the command.

This may be useful e.g. when the vehicle is driven by means of operator control elements configured on a touchscreen. The vehicle driver, when inputting an acceleration, steering or braking command, can therefore obtain direct feedback about the successful input of the command and is not reliant on observing the vehicle reaction and the associated time delay. Haptic feedback of this kind can thus contribute to increasing traffic safety.

According to different variant embodiments, any visible surface of the vehicle space may be formed by displays.

According to different variant embodiments, the vehicle can additionally have a camera observation unit. This camera observation unit may be fitted on or in the vehicle roof lining. It can be used e.g. to monitor the vehicle interior. The camera observation unit can be used to track the position of the vehicle driver, for example, so that the displays surrounding him accordingly display all display content necessary for driving the vehicle.

A method disclosed herein for driving a vehicle that has multiple displays comprises the following activities: determining the position of a vehicle driver in the vehicle, assigning displays to the determined position of the vehicle driver, ascertaining vehicle-relevant and/or route-relevant data, for example by means of sensors, generating display content from the ascertained vehicle-relevant and/or route-relevant data, transferring the generated display content to the assigned displays, displaying the generated display content on the assigned displays, the vehicle driver driving the vehicle on the basis of the displayed display content.

The method disclosed herein can be performed by means of a vehicle according to the embodiment(s) disclosed herein, for example. For a more detailed explanation of the individual method steps, reference is made to the descriptions of the devices of the vehicle embodiment(s) disclosed herein.

The driving of the vehicle on the basis of the displayed display content by the vehicle driver comprises controlling the vehicle according to the displayed display content. By way of example, the displays can be used to depict display content generated from video data recorded by means of image sensors, so that the driver controls the vehicle on the basis of camera pictures of the vehicle surroundings.

According to different variant embodiments, it is additionally possible for data of a memory unit to be selected and retrieved. From the retrieved data, it is subsequently possible for display content to be generated that can be transferred to the assigned displays and displayed thereon.

According to different variant embodiments, a vehicle driving authorization can be checked for example by virtue of the state of health, the age or the presence of a driver's license being checked. This can be accomplished by virtue of a comparison against stored data being effected.

According to further variant embodiments, the vehicle driver can be identified and the displays assigned to his position can be automatically individually customized. This allows the vehicle driver to be presented with information and control the vehicle using familiar and/or preferred display formats or presentations, regardless of the position that he/she occupies.

According to further variant embodiments, the vehicle can be driven by means of commands being input on one or more displays configured as a touchscreen. By way of example, the vehicle can be steered, braked and/or accelerated by means of commands being input on the touchscreens. After the commands have been input, it is possible, as explained above, for haptic feedback to be output, e.g. in order to signal the successful input of a command.

The invention will be explained in more detail below using an exemplary embodiment. In the associated drawings:

### BRIEF DESCRIPTION OF THE DRAWINGS

FIG. 1 shows a first schematic sectional depiction of a vehicle according to an embodiment of the invention, configured as an automobile,

FIG. 2 shows a second schematic sectional depiction of a vehicle according to an embodiment of the invention, and

FIG. 3 shows a third schematic sectional depiction of a vehicle according to an embodiment of the invention.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the examples explained below, reference is made to the accompanying drawings, which form part of these examples and show for illustration purposes specific embodiments in which the invention can be implemented. In this regard, direction terminology such as, for instance, “at the top”, “at the bottom”, “at the front”, “at the back”, “front”, “rear”, etc. is used with respect to the orientation of the Figures described. Since components of embodiments can be positioned in a number of different orientations, the direction terminology serves for illustration and is not restrictive in anyway whatsoever.

Other embodiments can be used and structural or logical changes can be made, without departing from the scope of protection of the present invention. The features of the various exemplary embodiments described herein can be combined with one another, unless specifically indicated otherwise. The description that follows should therefore not be interpreted in a restrictive sense, and the scope of protection of the present invention is defined by the appended claims.

In the context of this description, the terms “connected” and “coupled” are used to describe both a direct and an indirect connection and a direct or indirect coupling. In the Figures, identical or similar elements are provided with identical reference symbols, in so far as this is expedient.

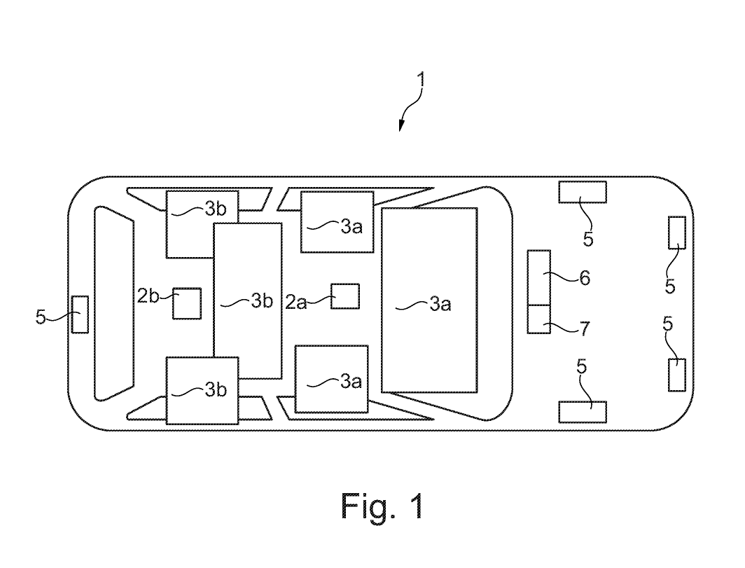

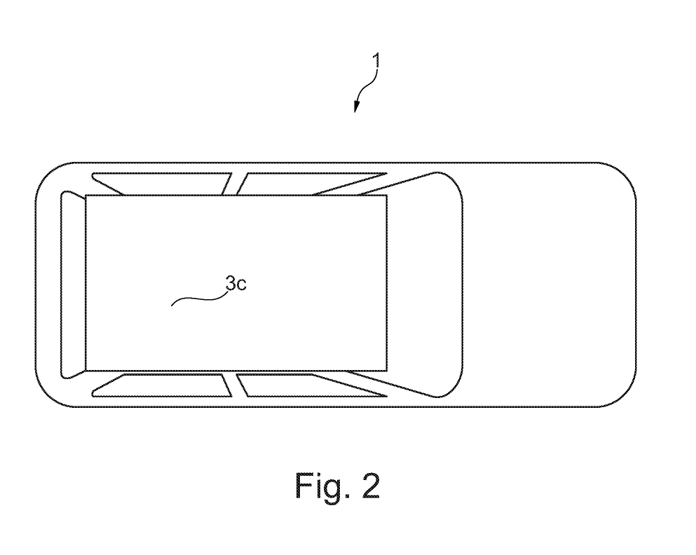

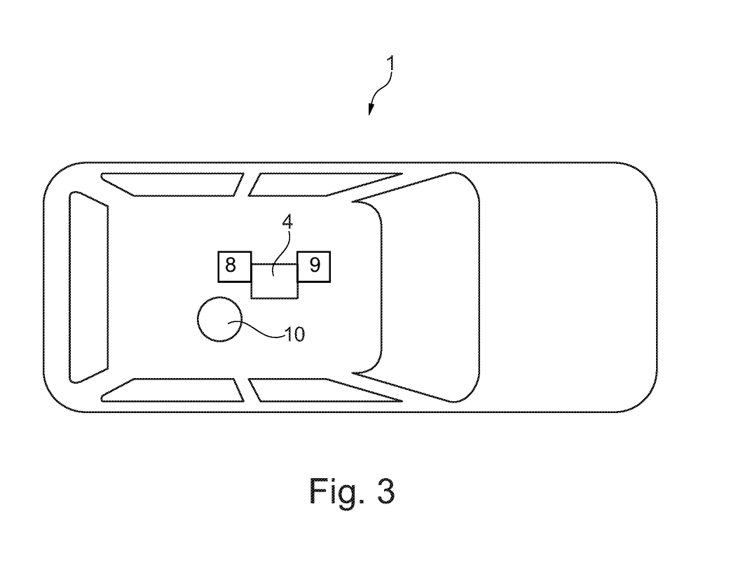

In an exemplary embodiment, the vehicle 1 according to the invention is an automobile. FIG. 1 shows a schematic depiction of a cross section as a plan view approximately from the center of the vehicle 1, so that the vehicle interior is visible. FIG. 2 shows the same vehicle 1 in a cross-sectional depiction as a plan view from a position beneath the outer surface of the vehicle roof. FIG. 3 likewise shows the same vehicle 1 in a cross-sectional depiction as a plan view from a position in the vehicle roof lining.

The vehicle 1 has two alternative driving positions 2a and 2b, which are vehicle seats in the example. A first alternative driving position 2a is in the front area of the vehicle 1, while a second alternative driving position 2b is in the rear area of the vehicle 1.

The two driving positions 2a, 2b each have three assigned displays 3a or 3b that are used for depicting display content. Moreover, a display 3c is provided that forms the vehicle roof lining (see FIG. 2) and is assigned both to driving position 2a and to driving position 2b. The displays 3a or 3b and 3c are each arranged such that depicted display content can be perceived from the assigned driving positions 2a and 2b.

Moreover, the vehicle 1 has a selection device 4 that is arranged in the area of the vehicle roof in the example and can be seen in FIG. 3. The selection device 4 is operable to select either driving position 2a or driving position 2b as the active driving position from which the vehicle may be controlled by a driver, and may be a switch. In the example described below, it is assumed that the vehicle driver occupies driving position 2b, so that position 2b is the active driving position.

Multiple sensors 5, which are arranged at the front and rear of the vehicle and at the sides in the example, are used for ascertaining vehicle-relevant and/or route-relevant data. By way of example, there may be image sensors that record a map of the route that is subsequently depicted on the displays. Vehicle windows and the outside view of the vehicle driver can therefore be dispensed with. Moreover, the sensors 5 record the current speed of the vehicle 1 and monitor the fill level of the fuel tank.

The processing unit 6 is schematically shown as being located in the front area of the vehicle 1 in the example, but it may also be located at any other position. In addition, a memory unit 7 is provided on which data are stored from which information about preferred display settings of the vehicle driver can be derived.

An identification device 8 can be used to identify the vehicle driver. The identification device 8 may be embodied as biometric sensor, such as a fingerprint scanner that is configured to check the fingerprint of the vehicle driver. Comparison with stored fingerprints allows the vehicle driver to be identified, so that it is possible to retrieve from the memory unit 7 those data that meet the individual needs of the identified vehicle driver.

The processing unit 6 receives data from the sensors 5, selects appropriate/required stored data of the memory unit 7, and retrieves said stored data from the memory unit 7. Utilizing some or all of the received and retrieved data, the processing unit 6 generates display content that is transferred to the displays 3b, 3c assigned to the active driving position 2b, which is the position assumed or detected to be occupied by the driver. The incorporation of stored data allows the display content to be individually customized to suit the needs of the vehicle driver.

The generated display content is subsequently depicted on the displays 3b, 3c. The vehicle driver now drives the vehicle 1 from the active driving position 2b utilizing the display content visible on displays 3b and/or 3c. By way of example, he can now steer the vehicle 1 according to the road profile that may be depicted on the middle display 3b. In addition, the current speed and the fill level of the fuel tank (along with other pertinent information) may be displayed on the displays 3b.

The displays 3a, 3b, 3c are configured as multi-function touchscreens in the example, so that the vehicle 1 can be driven by appropriately touching whichever of the displays 3a, 3b, 3c are assigned to/associated with the active driver position. To this end, in the example under discussion in which position 2b is active, operator control elements of the vehicle 1, such as e.g. steering wheel, turn signal lever, gas and brake pedals, are configured virtually on the displays 3b, so that the vehicle 1 can be steered, braked and/or accelerated by means of commands being input on the touchscreens.

The vehicle 1 in the exemplary embodiment additionally has a camera unit 10 that is arranged in the vehicle roof lining (FIG. 3) and operative to observe the vehicle interior. This unit is used for detecting/identifying and observing the vehicle driver. If this driver changes from driving position 2b to 2a, for example, the camera observation unit 10 can perceive this, so that the display content of the displays 3b can now be displayed on the displays 3a.

Optionally, the vehicle 1 of the exemplary embodiment can have a device 9 for checking the vehicle driving authorization and an identification device 8 for identifying the vehicle driver.

In addition, further driving positions may be available in the vehicle 1, the assigned displays of said driving positions depicting the display content that is important to the vehicle driver.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a first and a second multifunction display visible from a first and a second interior positions respectively;
a selection device operative to identify a vehicle occupant as a driver, determine a location of the driver within the vehicle, designate as an active driving position the first interior position when the driver is located at the first position, and designate as the active driving position the second interior position when the driver is located at the second position; and
a processing unit operative to transfer video relevant to vehicle operation to the one of the displays visible from the active driving position and enabling control of the vehicle from the active driving position.

2. The vehicle of claim 1, wherein the selection device comprises a camera operative to monitor the location of the driver.

3. The vehicle of claim 2, wherein the selection device uses facial recognition to monitor the location of the driver.

4. The vehicle of claim 1, wherein the selection device comprises and/or receives inputs from an authorization device operative to check whether the vehicle occupant meets one or more conditions required to be designated as the vehicle driver.

5. The vehicle of claim 1, wherein the selection device comprises and/or receives inputs from an identification device operative to determine an identity associated with the driver, and the displayed video is customized in accordance with the identity.

6. The vehicle of claim 5, wherein the identification device comprises a biometric sensor.

7. The vehicle of claim 1, wherein the first display is one of a first set of displays assigned to the first driving position, and the second display is one of a second set of displays assigned to the second driving position.

8. The vehicle of claim 1, wherein at least one of the displays comprises a touchscreen operative to allow the driver to make vehicle control inputs.

9. A vehicle comprising:
first and second displays visible from first and second interior positions respectively;
a selection device for identifying a vehicle occupant as a driver and determining which one of the interior positions is occupied by the driver; and
a processing unit for transferring video relevant to vehicle operation to the display visible from the occupied position and enabling control of the vehicle from the occupied position.

10. The vehicle of claim 9, wherein the selection device comprises a camera operative to monitor a location of the driver relative to the first and second interior positions.

11. The vehicle of claim 10, wherein the selection device uses facial recognition to monitor the location of the driver.

12. The vehicle of claim 9, wherein the selection device comprises and/or receives inputs from an authorization device operative to check whether the vehicle occupant meets one or more conditions required to be designated as the vehicle driver.

13. The vehicle of claim 9, wherein the selection device comprises and/or receives inputs from an identification device operative to determine an identity associated with the driver, and the displayed video is customized in accordance with the identity.

14. The vehicle of claim 13, wherein the identification device comprises a biometric sensor.

15. The vehicle of claim 9, wherein the first display is one of a first set of displays assigned to the first driving position, and the second display is one of a second set of displays assigned to the second driving position.

16. The vehicle of claim 9, wherein at least one of the displays comprises a touchscreen operative to allow the driver to make vehicle control inputs.

17. A vehicle comprising:
a plurality of displays;
a selection device for identifying a vehicle occupant as a driver and determining a position of the driver; and
a processing unit for transferring video relevant to driving to at least one of the displays visible from the position and enabling control of the vehicle from at least one of the displays.

18. The vehicle of claim 17, wherein the selection device comprises and/or receives inputs from an identification device operative to determine an identity associated with the driver, and the displayed video is customized in accordance with the identity.

19. The vehicle of claim 18, wherein the identification device comprises a biometric sensor.

20. The vehicle of claim 17, wherein the plurality of displays comprises a first set of displays assigned to a first alternative driving position, and a second set of displays assigned to a second alternative driving position.
